(19) United States
(12) Patent Application Publication
(10) Pub. No.: US 2001/0019950 A1
(43) Pub. Date: Sep. 6, 2001

(54) RF signal receiving method and circuit with high degree of signal isolation

(75) Inventor: Shih-Kuei Wei, Hsinchu (TW)

Correspondence Address: Ladas & Parry, 26 West 61st Street, New York, NY, 10023, US

(73) Assignee: MICROELECTRONICS TECHNOLOGY, INC.

(21) Appl. No.: 09/792,278

(22) Filed: Feb. 22, 2001

(30) Foreign Application Priority Data
Feb. 29, 2000 (TW) 89103440

(51) Int. Cl. H04B 1/26

(52) U.S. Cl. 455/318; 455/323; 455/333; 455/326

(57) ABSTRACT

A down-converting receiving method for RF signal as well as a receiving circuit implementing said method is disclosed. The method is characterized by down-converting the first and the second polarized signals by means of two harmonic mixers being used to receive the first and the second polarized signals respectively and a harmonic signal output from a local oscillator common to the two harmonic mixers; and isolating the first and the second polarized signals by means of a filter serially connected between the local oscillator and at least one of the two harmonic mixers. By means of the method disclosed, a lot of the elements to isolate two differently polarized signals are easy to design, as well as effective in obtaining a good isolating effect, even for a higher applied frequency.

### BACKGROUND OF THE INVENTION

1. Field of the Invention

This invention relates to a satellite signal receiving method and circuit and more particularly to a RF (radio frequency) down-converting method and circuit for receiving and down-converting, with a high degree of signal isolation, a bipolarized satellite RF signal.

2. Description of the Prior Art

For providing a channel with the largest utility rate, a microwave signal is usually transmitted in the form of a bipolarized signal via satellite. The so-called bipolarization can be either a linear polarization (vertically polarized and horizontally polarized) or a circular polarization (left-handed polarized and right-handed polarized). On the other hand, serving as a receiving apparatus located on earth, a bipolarized signal down-converting circuit is used to receive the bipolarized signal and to selectively output one kind of polarized signal. To avoid interference of the selected signal by an un-selected signal, the two polarized signals in a bipolarized signal should be clearly isolated.

FIG. 1 is a diagraph of a conventional down converting circuit, which outputs only one kind of polarized signal at a time. The so-called polarized signal hereinafter refers to a horizontally polarized signal or a vertically polarized signal with respect to a linearly polarized signal, or to a left-handed polarized signal or a right-handed polarized signal with respect to a circularly polarized signal. To be brief, the following description is directed to the aspect of a linear polarization. In the circuit in FIG. 1, a vertically polarized signal is received by an input terminal 11 and a horizontally polarized signal is received by an input terminal 21. If the vertically polarized signal is desired, a controller 31 will turn the amplifier 22 off and turn the amplifier 12 on, from a control device such as from a channel selecting circuit. In terms of a general high-frequency GaS transistor, a gain of 11 dB is obtainable in an ON status, and a loss of 10 dB happens in an OFF status. Thus, by virtue of the difference in status of the two amplifiers', an isolation of 21 dB is obtainable in connection with the vertically polarized signal and the horizontally polarized signal. Moreover, by means of quarter-wavelength transmitting lines 13 and 23, connected between an amplifier 32 and two amplifiers 12, 22 respectively, the desired vertically polarized signal being amplified by the amplifier 12 will be completely transferred to the amplifier 32 with no energy loss, rather than return to the amplifier 22. Consequently, a better noise figure is obtained. The above circuit is cheap and thus is widely used, especially for a signal having a frequency between C band and Ku band.

However, the transmitting line having a particular length is not suited to a wideband design since it is only suitable for a narrowband design, due to its property of utilizing its special length to block an un-selected signal. Moreover, the isolation between the two polarized signals is determined by the two amplifiers constructed by FET transistors. Thus, the above isolation will decay with respect to a frequency up to a Ka band or a higher band such as higher than 20 GHz, due to the characteristic of the transistor and the manufacturing precision of the transmitting line. In other words, as the applied frequency goes up, the gain and loss in each amplifier will decay. Thus, an interval counted by the gain and loss in different transistors becomes small. For example, in case of Ku band (12 GHz), a gain of 11 dB plus a loss of 10 dB, will result in a signal isolation of 21 dB. Nevertheless, in the case of a frequency of 20 GHz, the gain decays to 6 dB, the loss becomes 9 dB, and thus the signal isolation is only 15 dB.

On the other hand, such a conventional circuit utilizes a fundamental mixer and a local oscillator to down-convert the frequency of the received polarized signal. However, even though such a fundamental mixer is easily designed for a frequency under 150 Hz, it is difficult to design with a good yield over a frequency higher than 20 GHz. The local oscillator experiences the same situation. Moreover, since a desired signal to be output is selected by a on to alternatingly turning on or off the amplifiers, the two input terminals will have a varied impedance in response to such a selection which makes it unstable. Such instability in input impedance will affect input return loss and result in interference between the two input terminals, which in turn will decrease the isolation of the two polarized signals. Such a phenomenon is especially serious for a down-converting circuit utilizing a circular wave-guide and double probes to receive a microwave signal.

FIG. 2 shows another conventional receiving circuit, in which amplifiers 42 and 52 will be simultaneously turned on during operation. Moreover, the radio frequencies respectively input from the input terminals 41 and 51 are mixed with a local oscillating signal generated from a local oscillator 61 by two fundamental mixers 44 and 54 respectively. In addition, two band-pass filters 45 and 55 are respectively provided between the two respective mixers and the local oscillator. Furthermore, a switching circuit 62 is used to select the signal to be output. By means of the above construction, anyone of the output terminals could output a vertically polarized signal or a horizontally polarized signal.

In such a receiving circuit, the problem with regards to the input impedance has been solved by simultaneously turning on the two amplifiers 42 and 52. However, such a receiving circuit is still adapted to a Ku band only, rather than to a radio frequency higher than 21 GHz. In detail, a down-converted frequency F_{IF} stems from the subtraction of the local oscillating frequency F_{LO} from the radio frequency F_{RF}. If a down-converted intermediate frequency of 1 GHz is desired, the local oscillator should have a frequency of 20 GHz with respect to a radio frequency of 21 GHz to be received. In addition, the two band-pass filters 45 and 55 should allow a pass of a signal having a frequency of 20 GHz, However, the design with respect to such a local oscillator and filters is relatively complicated, and the other un-selected signal is difficult to be blocked due to an approach of its frequency to the band-pass frequency of the filter. A leakage of the horizontally polarized signal will flow along a route P2 shown in FIG. 2 and then interfere with the selected vertically polarized signal transmitted along a route P1 shown in FIG. 2. Such a leakage becomes more serious for a higher radio frequency. Thus, for the radio frequency higher than Ka band, a better design would be necessary.

### SUMMARY OF THE INVENTION

An object of this invention is to provide a RF signal receiving method and circuit having a high degree of signal isolation, especially adapted to a frequency higher than Ka band.

To achieve the above object, the present invention discloses a RF signal receiving method for receiving and down-converting a first polarized signal and a second differently polarized signal, being characterized by:

down-converting the first and the second polarized signals by means of two harmonic mixers for receiving the first and the second polarized signals respectively and a harmonic local oscillating signal output from a local oscillator common to the two harmonic mixers; and

isolating the first and the second polarized signals by means of a filter serially connected between the local oscillator and at least one of the two harmonic mixers.

Moreover, to obtain the above object, the present invention discloses a RF signal receiving circuit for receiving a first polarized signal and a second differently polarized signal, being characterized in comprising:

a local oscillator for outputting a local harmonic signal;

a first harmonic mixer for receiving and mixing the first polarized signal and the local harmonic signal so as to generate a first down-converted polarized signal of a down-converted frequency;

a second harmonic mixer for receiving and mixing the second polarized signal and the local harmonic signal so as to generate a second down-converted polarized signal of the down-converted frequency; and

a filter provided between the local oscillator and at least one of the two harmonic mixers to allow the local harmonic signal to pass to at least one harmonic mixer and to isolate the two polarized signals.

By means of the above circuit, since the frequencies of the two polarized signals are down-converted by respective harmonic mixers in conjunction with the local harmonic signal, the local oscillator could be designed with simplicity for a lower frequency output with respect to a desired middle frequency output by the harmonic mixer. Moreover, by virtue of the lower frequency provided, the filter can also be implemented by a simpler design. Therefore, it is enough to effectively isolate the selected polarized signal from the undesired polarized signal under a simpler design.

In another embodiment, each of the harmonic mixers is constructed by active elements and thus can be used as a selecting element for outputting the desired polarized signal. Moreover, each polarized signal is received by an amplifier in advance and then received by the harmonic mixer. Thus, a stable input impedance and a good input return\loss are obtainable but an interference between the two inputs is avoided.

The advantages and features of this invention can be easily comprehended by persons skilled in the art through the drawings and detailed explanations.

### BRIEF DESCRIPTION OF THE DRAWINGS

FIG. 1 illustrates a diagram of a conventional RF signal receiving circuit.

FIG. 2 illustrates a diagram of another conventional RF signal receiving circuit.

FIG. 3 illustrates a diagram of an RF signal receiving circuit in accordance with this invention.

### DETAILED DESCRIPTIONS OF EMBODIMENTS

The present invention can be used to receive a bipolarized signal transmitted from a satellite, such as a linear or circular polarization signal. Hereinafter, a first polarized signal and a second polarized signal are used to be representative of the bipolarized signal in the linearly polarization or circular polarization. Moreover, even though a microwave signal having a frequency of Ku or Ka band is illustrated in hereinafter as an example, such a frequency can in practice go down or up to S.C or one higher than Ka band. Furthermore, for the sake of clarity, any possible input frequency is referred as a radio frequency. And, an output frequency of 1-2 GHz in a general satellite broadcasting system is illustrated as a desired output frequency and referred to in this invention as an intermediate frequency (IF). However, such a band is variable, based the selected radio frequency and the local oscillating frequency.

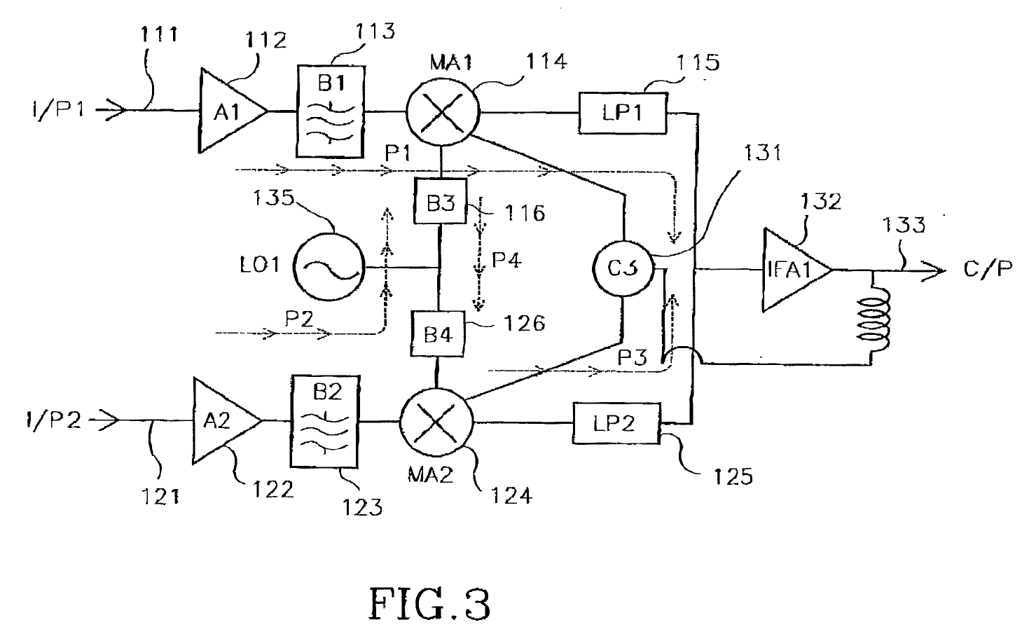

FIG. 3 shows a diagram of an RF signal receiving circuit in accordance with this invention. Such a circuit comprises a first part for receiving and down-converting a first polarized signal, a second part for receiving and down-converting a second polarized signal, and a common part for outputting a down-converted signal in a conjunction with either the first or the second part. The first part includes a first input terminal 111, a low noise amplifier 112, a band pass filter 113, a harmonic mixer 114, a low pass filter 115, and a band pass filter 116. The second loop includes a second input terminal 121, a low noise amplifier 122, a band pass filter 123, a harmonic mixer 124, a low pass filter 125, and a band pass filter 126. In the common part, a local oscillator 135, a controller 131, an intermediated frequency amplifier 132, and an output terminal 133 are included.

The harmonic mixers 114 and 124 are second harmonic mixers constructed by active elements, particularly by PET transistor. In addition, the harmonic mixers 114 and 124 can be selectively turned on or off by the controller 131. The controller 131 is commanded by a selection signal sent from a channel selector (not shown). The selection signal is input to the controller 131 via a cable (not shown) connected to the output terminal 133.

If the first polarized signal is desired, the harmonic mixer 114 is turned on by the controller 131 and the harmonic mixer 124 is turned off thereby. On the contrary, if the second polarized signal is desired, the harmonic mixer 114 is turned off and the harmonic mixer 124 is turned on by the controller 131. The selected polarized signal is always output from the output terminal 133 after being down-converted.

Now, the reason why the above receiving circuit of this invention can obtain a better signal isolation is described here.

As shown in FIG. 3, with respect to a desired first polarized signal, analysis with respect to four loops, i.e., P1, P2, P3, and P4 as shown, should be considered. The loop P1 indicates a main loop in connection with the desired polarized signal, in which the first polarized signal is received by the amplifier 112 and output from the IF amplifier 132 through the filter 113, the harmonic mixer 114, and the low pass filter 115. The loops P1, P2, and P3 are all related to interference coming from the un-desired second polarized signal. The loops P2 and P3 both indicate a second polarized signal leakage resulting from an un-ideal turn off of the harmonic mixer 124, and the loop P2 specially indicates leakage toward the harmonic mixer 114 while the loop P3 specially indicates leakage toward the IF amplifier 132. The loop P4 indicates leakage of the first polarized signal, as well as leakage of the IF signal, from the harmonic mixer 114 to the harmonic mixer 124.

With respect to a received RF signal having a frequency of 21 GHz (F_{RF}) and an output IF signal of 1 GHz in frequency (F_{IF}), the frequency of the local oscillating signal (F_{LO}) to be required would be 10 GHz in accordance with this invention. This is because the second harmonic mixer 114 has the operating principle as follows:

F_{IF}=F_{RF}−2F_{LO}

As a result, the filters 116 and 126 can be designed for the pass of signal of 10 GHz in frequency and its design is rather easy. Moreover, since the frequency to pass through the filters has a relative difference from the frequency of the RF signal, the filters 116 and 126 will decay the second polarized RF signal each at a range of 30 dB. Thus, based upon the decay of 30 dB contributed by each filter and a decay of 10 dB contributed by the turned off harmonic mixer 124, the leakage along the loop P2 will be decayed about 70 dB. As for the leakage signal in the loops P3 and P4, they are also well faded by the filters 116, 126 and the low pass filter 125.

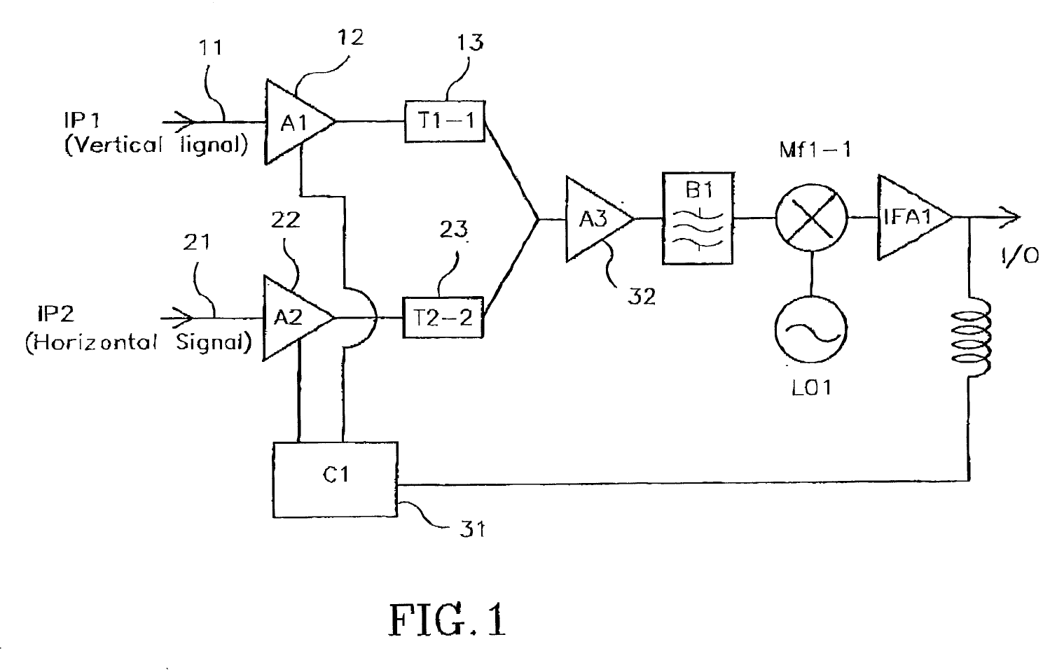

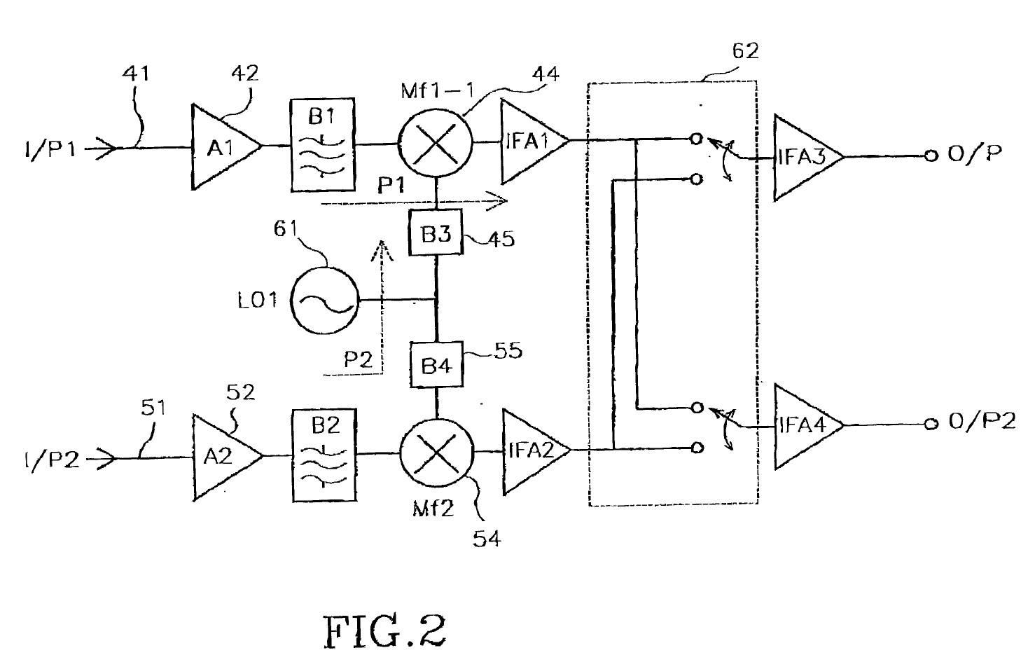

Therefore, an IF output having a good isolation from the second polarized signal is obtained and it is better adapted for high frequency than the conventional receiving circuit which utilizes the amplifier for switching, as shown in FIG. 1, or utilizes fundamental mixer to proceed with mixing, as shown in FIG. 2.

Moreover, since there are low noise amplifiers 112 and 122 provided between the harmonic mixers 114, 124 and the input terminals 111, 121 respectively and since both the low noise amplifiers are turned on in case of operation, the impedance at the input terminals will keep constant. Accordingly, a stable input impedance and a stable input return loss are obtainable, which is especially advantageous for a circularly polarized signal.

The above design can also be applied in a circuit construction as shown in FIG. 2. In detail, two harmonic mixers (not shown) are used to replace the two fundamental mixers 44 and 54 in the circuit shown in FIG. 2 so as to mix the received polarized signal with a local harmonic signal from the local oscillator. As for the signal output portion including the switching circuit 62 is not changed. However, a low pass filter can also be provided between the harmonic mixer and the IF amplifier so as to further decay any possible leaking undesired signal and to obtain a good isolation. By means of such an arrangement, a more improved isolation between two polarized signals than the arrangement in FIG. 3 is obtainable,

Moreover, even though a second harmonic mixer is illustrated as an example of the harmonic mixer in the above description, a third or fourth harmonic mixer can also be used as the harmonic mixer, by which the local oscillator and filter can be designed at a lower frequency and thus is easy to design and obtain a good isolating effect.

While the present invention is described by way of preferred embodiments, it should be understood that the embodiments are used only to illustrate the technical concept of the present invention without limiting the scope thereof. It is therefore intended that all modifications and alterations that are readily apparent to those skilled in the art be within the scope as defined in the appended claims.

What is claimed is:

1. A down-converter receiving method for receiving a first polarized signal and a second differently polarized signal, being characterized by:
down-converting the first and the second polarized signals by means of two harmonic mixers for receiving the first and the second polarized signals respectively and a harmonic local oscillating signal output from a local oscillator common to the two harmonic mixers; and
isolating the first and the second polarized signals by means of a filter serially connected between the local oscillator and at least one of the two harmonic mixers.

2. The method as claimed in claim 1, wherein the two harmonic mixer is constructed by active elements and can be selectively actuated by a control from a channel selecting mechanism so that one of the first and the second polarized signals can be selectively down-converted and output.

3. The method as claimed in claim 1, wherein the first and the second polarized signals are received by low noise amplifiers in advance and then received by the harmonic mixers, respectively.

4. A down-converter receiving circuit for receiving a first polarized signal and a second differently polarized signal, being characterized in comprising:
a local oscillator for outputting a local harmonic signal;
a first harmonic mixer for receiving and mixing the first polarized signal and the local harmonic signal so as to generate a first down-converted polarized signal of a down-converted frequency;
a second harmonic mixer for receiving and mixing the second polarized signal and the local harmonic signal so as to generate a second down-converted polarized signal of the down-converted frequency; and
a filter provided between the local oscillator and at least one of the two harmonic mixers to allow the local harmonic signal to pass to the at least one harmonic mixer and to isolate the two polarized signals.

5. The circuit as claimed in claim 4, wherein the two harmonic mixers are constructed by active elements and can be selectively activated by a control from a channel selecting mechanism so that one of the first and the second polarized signals can be selectively down-converted and output.

6. The circuit as claimed in claim 4, further comprising two low noise amplifiers each amplifying one of the two polarized signals and then output to the harmonic mixer.
